(19) United States
(12) Patent Application Publication
(10) Pub. No.: US 2005/0258098 A1
(43) Pub. Date: Nov. 24, 2005

(54) Method for regulating a membrane filtering installation

(76) Inventors: Nathalie Vincent, Ouint-Fonsegrives (FR); Corrine Cabassud, Saint Orens De Gameville (FR); Michel Cabassud, Saint Orens De Gameville (FR); Laurence Durand-Bourlier, Clamart (FR); Jean-Michel Laine, Ecquevilly (FR)

Correspondence Address: Morris Liss;Pollock Vande Sande & Amernick, P O Box 19088, Washington, DC, 20036-3425, US

(21) Appl. No.: 10/450,381

(22) PCT Filed: Dec. 4, 2001
(86) PCT No.: PCT/FR01/03828

§ 371 Date: Dec. 1, 2003

(30) Foreign Application Priority Data
Dec. 13, 2000 (FR) 00/16249

(51) Int. Cl. B01D 65/08

(52) U.S. Cl. 210/636; 210/650; 210/739; 210/741

(57) ABSTRACT

The invention concerns a method for avoiding irreversible membrane clogging while maximising productivity, whatever the quality of the fluid at the installation intake. It consists in automatically controlling the installation operating parameters by performances induced by the quality of the fluid to be treated, based on predictions concerning the evolution of the membrane clogging carried out by modelling with a neuron network so as to simulate the long term operating conditions of the membrane filtering installation, the model enabling, on the basis of the quality of the in-flowing fluid and on the state of the membranes during a given cycle, to calculate the evolution of the clogging state of said membranes on a time basis, on a specific horizon, said calculation being performed for a simulated in-flowing quality, constant or variable, on said horizon (H) and to control and adjust the installation operating parameters.

The present invention relates to the operation of membrane filtration plants and more particularly to the regulating of such plants by predictive modelling of the clogging, for example by neural networks.

It is known that the use of membranes, especially ultrafiltration membranes, has become widespread in recent years, especially in the field of the production of potable or industrial water. The hollow-fibre membranes thus used allow the water quality requirements to be met, even should the resources be degraded.

At the present time, there is considerable research with the objective of improving the productivity of plants for producing potable or industrial water using such membranes. This research is based on knowledge of the various factors and phenomena involved in the filtration of surface water or other fluids of variable quality. The first factor limiting production by the membranes results from the deposition of particles on the surface and/or in the pores of the membranes. This first factor is a short-term phenomenon. To remove these particles, which are deposited on the membranes in the form of a layer or cake, hydraulic, pneumatic or hydropneumatic washing operations are periodically carried out. The second limiting factor is the adsorption of organic matter on the surface of the membranes and in the pores of the latter, this factor constituting a long-term phenomenon.

That part of membrane clogging that can be removed by hydraulic, pneumatic or hydropneumatic washing is often called reversible clogging, whereas the other part is called irreversible clogging.

There are many parameters involved in the clogging of the membranes used in water treatment. On the one hand, there are parameters relating to the quality of the fluid to be treated and, on the other hand, operating parameters, these two types of parameters being interdependent.

It will be understood that one of the ways of knowing how to increase the productivity of the filtration plant lies in having a better understanding of the phenomena involved in membrane clogging. For this purpose, one is led to modelling the membrane plant. Although a very large number of studies devoted to clogging have been carried out, the models produced are not applicable for describing the clogging of the membranes by complex fluids such as natural water. However, a number of promising tools allowing simulation models to be developed do exist. Among them, mention may be made of artificial neural networks. Such networks have been used successfully in predicting short-term performance. Moreover, it has been envisaged to develop a model for predicting the productivity of a plant for obtaining potable water, this prediction relying both on the quality of the water to be treated and on long-term operating parameters, taking into account the minimum number of parameters. In this regard, the reader may refer to the publication “Neural networks for long term prediction of fouling and backwash efficiency in ultrafiltration for drinking water production” by N. Delgrange-Vincent et al., published in Desalination 131, pp. 353-362, 2000.

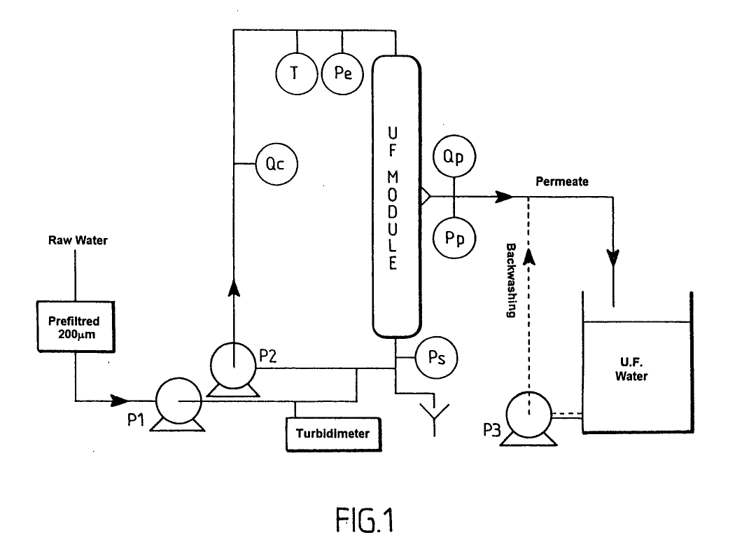

Referring now to FIG. 1 of the appended drawings, this shows schematically a pilot ultrafiltration plant used to obtain potable water.

This figure shows schematically an ultrafiltration module of the hollow-fibre type. The water to be treated is prefiltered beforehand and then injected using a pump P1 into the circulation loop of the module, a pump P2 circulating it in the loop.

The factors relating to the quality of the water are the following:
temperature T;
conductivity;
pH;
dissolved oxygen (O₂) concentration;
TOC (total organic carbon);
redox potential EH;
turbidity (Tur);
UV absorbence (uv).

The plant operating parameters are the following:
transmembrane pressure, Pₜₘ;
permeate flow rate, Qp;
circulation flow rate, Q_{C};
circulation loop purge flow rate, Q_{purge};
filtration time, t_{F};
backwashing pressure, P_{BW};
backwashing time, t_{BW};
hydraulic backwashing flow rate, Q_{BW};
chlorine concentration (or concentration of another chemical additive) of the backwashing water, [Cl₂]_{BW};
the characteristic parameters governing the injection of additives during the filtration cycle, for the purposes of increasing the performance of the filtration and/or the quality of the filtered effluent.

The plant produces a constant permeate flow rate Qp, causing the pressure to rise during the filtration period. The circulation flow rate Q_{C} represents the feed rate at the inlet of the module. The membranes periodically undergo hydraulic washing with filtered water to which chlorine has been added. In this way, the level of membrane clogging is reduced.

The total hydraulic resistance of the ultrafiltration module is expressed by the equation:
R=Pₜₘ/(μ.Qp/A)
where μ is the temperature-dependent viscosity of the water, Pₜₘ is the average transmembrane pressure and A is the membrane area.

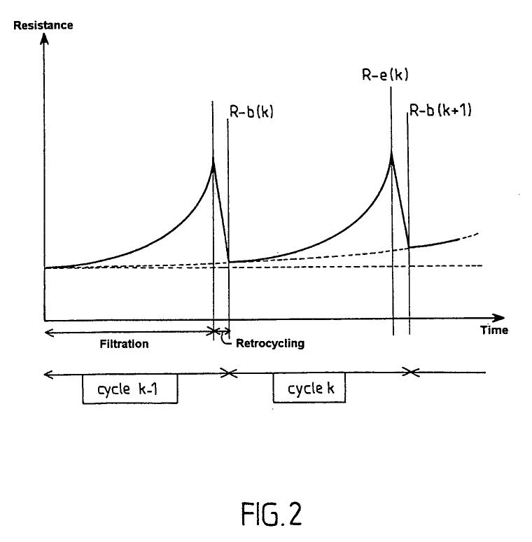

The total resistance is made up of the resistance of the membrane, the resistance due to reversible clogging and the resistance due to irreversible clogging. In the case of a constant permeate flow rate, the resistance builds up during the filtration period and decreases after backwashing, as shown in FIG. 2 of the appended drawings.

Consequently, a production curve consists of cycles, each of them being characterized by the resistance (Re) at the end of the filtration cycle and the resistance (Rₛ) at the start of the next cycle, that is to say after hydraulic washing. Variations in the durations of the (Rₑ) and (Rₛ) cycles therefore suffice to characterize and describe the variations in the filtration process.

The performance of a pilot production plant may be expressed through:
the gross production, that is to say the permeate flow rate at the outlet of the module; and
the net production, taking into account the water losses during the washing operations and the lack of production during the washing period.

In the case of backwashing, the net flow rate is expressed by the equation:
Qpₙₑₜ=(V_{F}−V_{BW})/(t_{F}+t_{BW})
in which:
V_{F} is the filtered volume;
V_{BW} is the backwashing volume;
t_{F} is the filtration time; and
t_{BW} is the backwashing time.

The object of the present invention is to provide a method of regulating a membrane filtration plant designed so as to prevent irreversible clogging of the membranes while maximizing the productivity (estimated by a suitable criterion, such as the net production), whatever the quality of the fluid entering the system. In other words, the problem that has to be solved by the present invention consists in slaving the performance of a filtration plant to the quality of the incoming fluid; this slaving depends directly on the change in the clogging of the said plant, which change is predicted by neural network modelling so as to simulate the long-term operation of the filtration plant, the model allowing the plant to be monitored and controlled in real time.

If we consider the concept of the critical flux, as explained in the literature, it is preferable to operate with a flux low enough to completely avoid reversible clogging. Moreover, it has been observed that when the hydraulic resistance of the membranes increases at the start of a cycle, the amount of irreversible clogging increases with time. This observation means that the more the membrane is clogged, the greater the amount of irreversible clogging. A problem then arises which is due to the fact that the flux produced is extremely low when the treated water is of poor quality. A compromise consists in finding, for each cycle, the operating conditions such that, even if clogging does occur, it is possible to eliminate it by hydraulic washing and to ensure that this clogging is not irreversible.

To effect this regulation, it is possible to vary a number of operating parameters, which, as mentioned above, may be chosen from:
transmembrane pressure, Pₜₘ;
permeate flow rate, Qp;
circulation flow rate, Q_{C}, with a possible switch from a recirculation mode to a transverse mode;
circulation loop purge flow rate, Q_{purge};
filtration time, t_{F};
backwashing pressure, P_{BW};
backwashing time, t_{BW};
hydraulic backwashing flow rate, Q_{BW};
chlorine concentration (or concentration of another chemical additive) of the backwashing water, [Cl₂]_{BW};
the characteristic parameters governing the injection of additives during the filtration cycle, for the purposes of increasing the performance of the filtration and/or the quality of the filtered effluent.

The present invention has adopted, as an example, for this regulation, on the one hand the filtration time and on the other hand the permeate flow rate, it being understood that other combinations of operating parameters may also be used without thereby departing from the scope of the invention.

It would be conceivable to work with a minimum permeate flow rate and a minimum filtration time so as to choose the most prudent approach with respect to the clogging phenomenon, but in this case the productivity would be too low. According to the invention, the productivity parameters, such as for example the permeate flow rate and the filtration time, are therefore varied so as to find a compromise between the highest water production on the one hand and the amount of clogging on the other, this compromise being quantified using a neural network model which calculates, according to the quality of the fluid to be treated and the state of the membrane for a given cycle, the change in the membrane permeability as a function of time, over a defined horizon, the quality of the fluid being simulated (constant or variable) over this horizon.

A priori, two situations may arise:
1) the quality of the fluid to be treated is such that the membrane clogging increases strongly over the prediction horizon, it being possible for the state of membrane clogging to be described by parameters such as the hydraulic resistance, the permeability or the transmembrane pressure. It is then necessary to reduce the performance demanded of the membrane filtration module (such as, for example, the flow rate and/or the filtration time) while waiting for the quality of the fluid treated to improve;
2) the quality of the fluid is relatively high and the amount of membrane clogging remains low. Production at the next cycle can then be increased.

It was mentioned above that the state of the membrane at a given cycle may be characterized by its permeability, its hydraulic resistance at the start of a cycle or its transmembrane pressure. The method of regulation forming the subject-matter of the invention sets a clogging level limit at the start of the cycle, characterized by a permeability limit (Lp_c) and ensures that the plant operates with a permeability equal to or greater than this value.

Thus, according to the invention, at each cycle k the pilot plant will:
1) acquire the values of all the quality parameters and of the operating conditions needed for the model;
2) input them into the neural network model, which will calculate the resistance over a certain prediction horizon, thereby allowing the permeability at the end of H cycles, i.e. Lp(k+h), to be obtained. For these calculations, the quality parameters and the module operating conditions are considered as being constant over H cycles and equal to the corresponding values of cycle k. It is also possible to take a constant value equal to the value averaged over the n cycles that precede cycle k. It is also possible to envisage taking account of a profile corresponding to the variations in the values of these parameters over H cycles.

Two cases may be considered:
Case A: Lp(k+H)<Lp_c: this means that the membrane becomes clogged above the fixed limits. It is therefore necessary to reduce the imposed productivity;
Case B: Lp(k+H)>Lp_c: this means that there is no immediate risk of the membrane clogging. It is therefore possible to increase the productivity imposed on the modules by varying one or more of the operating parameters, that is to say, in this non-limiting example, the permeate flow rate and/or the filtration time;
3) using the model, the permeability at the end of H cycles, that is to say Lp(k+H), is calculated for all permeate flow rate Qp-filtration time t_{F} pairs and that pair for which Lp(k+H)>Lp_c and for which the productivity is highest is chosen. It would also be possible to use a procedure for optimizing the net flow rate.

There remains to be defined what parameters have to be chosen in order to apply this regulation. It is necessary to choose the following:
the prediction horizon H;
the minimum and maximum values of the productivity parameters allowed, such as for example the permeate flow rate and the filtration time;
the steps in the variations of these parameters; and
the value of the permeability limit Lp_c.

This choice of regulating parameters is made using pilot plant regulating simulations.

These simulations were carried out according to the abovementioned strategy. To test the response of the model, six manipulations were made, during which the hydraulic resistance of the module was or was not made to drift. The corresponding water quality curves were plotted as a function of time.

At each cycle k, the experimental parameters and the operating conditions for the start of a cycle were introduced as input into the model and the neural network calculated, in loop mode, the hydraulic resistance over a horizon of H cycles starting from the assumption that all the input parameters are constant over these cycles. The permeability Lp_i(k+H) after H cycles was thus obtained and the net flow rate Qp_net_i was calculated.

All the (Qp;t_{F}) pairs that could be applied to the next cycle were tested and, for each of them, the permeability Lp(k+H) after H cycles was calculated:
if Lp_i(k+H)>Lp_c, the pair for which the net flow rate is greater than Qp_net_i is kept, but with the condition Lp(k+H)>Lp_c;
if Lp_i(k+H)<Lp_c, the pair for which Lp(k+H)>Lp_c is obtained is kept, if possible maximizing the net flow rate.

Next, the neural network is used to simulate the actual response of the pilot plant to the next cycle k+1, by inputting into it the permeate flow rate Qp and filtration time t_{F} commands calculated beforehand, together with the new water quality and operating condition parameters. The network calculates the resistance at the end of the cycle and at the start of the next cycle.

To take into account possible large variations in the quality of the fluids to be treated, it is necessary to choose a horizon long enough to account for any drift in hydraulic resistance but, however, short enough for it to be possible to consider that the water quality is constant over the horizon H.

The permeate flow rate and filtration time limits and variation steps that have to be chosen in order to apply the regulation were also defined. The variation steps are the steps between the various flow rate and time values tested in order to optimize the net flow rate.

Finally, the influence of the choice of permeability limit value Lp_c on the controls and on the permeability drift was tested.

These simulations were used to validate the method of regulation of the invention using the neural network model to simulate the response of the pilot plant. It was thus possible to verify that the permeability was maintained at a particularly high level and that the net flow rate was high compared with a conventional operation without regulation.

This technique was then validated directly on site, on the pilot ultrafiltration plant.

The regulation algorithm was constructed. The essential points of the strategy on the basis of which this algorithm was constructed were the following:
variations in the filtration time and permeate flow rate (t_{F} and Qp, respectively) controls between fixed minimum and maximum limits;
in the case of the permeate flow rate, a variation from one cycle to the next limited to 5 l.h⁻¹.m⁻²;
search, for each cycle, for the pair (t_{F} and Qp) which produces the highest net flow rate with the constraint: Lp(k+H)>Lp_c, Lp_c being fixed;
if t_{F}=t_{F}_{_{—}}min., Qp=Qp_min. and assuming that Lp(k+H)<Lp_c, generation of an alarm. According to one embodiment, the alarm triggers an overall shut-down of the pilot plant. However, a more progressive sequence of actions may be introduced, such as an alarm threshold above which the controls are kept at the minimum for a few cycles and another threshold above which the pilot plant is shut down, or else the intervention of the operator is requested.

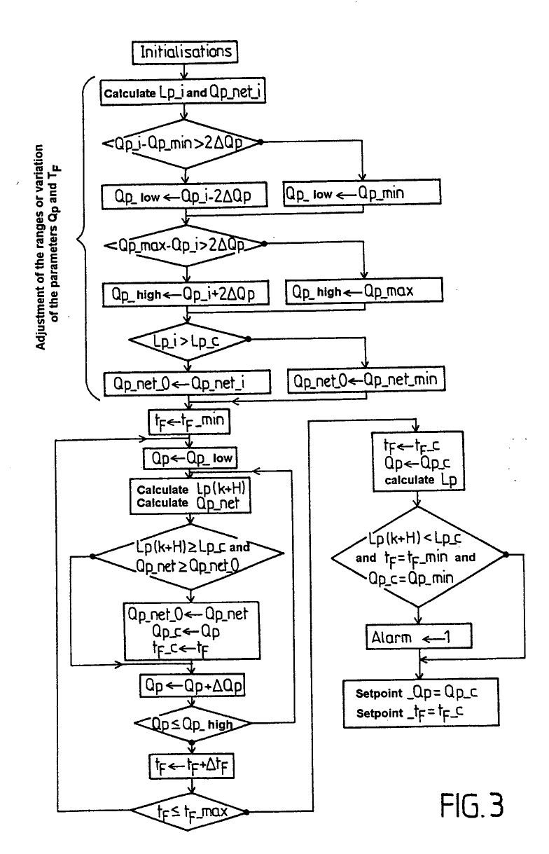

The flowchart of the algorithm is illustrated by FIG. 3.

The constants involved in the algorithm are:
the permeability setpoint: Lp_c;
the length, as number of cycles, of the prediction horizon: H;
the minimum and maximum limits of variation of Qp and t_{F}: Qp_min, Qp_max, t_{F}_{_{—}}min, t_{F}_{_{—}}max;
the Qp and t_{F} variation steps during the test of all the (Qp, t_{F}) pairs: ΔQp and Δt_{F}.

The local variables are:
the permeate flow rate Qp and the filtration time t_{F};
Qp_net0, the net flow rate used as reference for comparing the performance of the (Qp and t_{F}) pairs;
the variations in Qp being limited from one cycle to another to ±5 l.h⁻¹.m⁻², Qp_low and Qp_high are the values of the limits between which Qp may vary;
Qp_i and Qp_net_i and Lp_i are the initial flow rate, initial net flow rate and initial permeability;
Lp is the vector of the permeabilities calculated by the neural network;
Qp_net is the net flow rate calculated with the current values of Qp and t_{F};
Qp_c and t_{F}_{_{—}}c are the flow rate and time control values used, these being transmitted as call variables at the exit of the program; and
alarm is a Boolean, transmitted at the exit of the program, which indicates whether or not there is a critical operating situation.

The call variables are:
inputs: T, Qp, t_{F}, Qc, Tur, TOC, O₂, pH, UV, EH, Xi, P_{BW}, [Cl₂]_{BW}, t_{BW}, Pₜₘ;
outputs: Qp, t_{F}, alarm.

In the “initializations” block, Qp_c and t_{F}_{_{—}}c are initialized to Qp_min and t_{F}_{_{—}}min respectively and the alarm to 0.

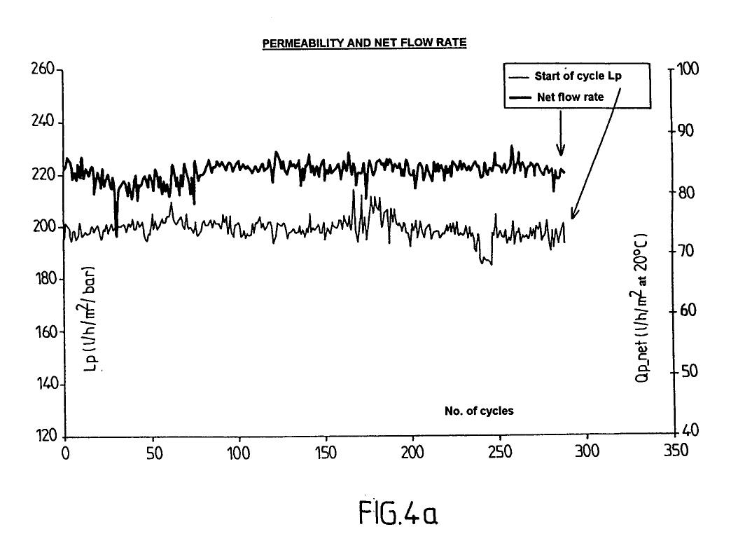

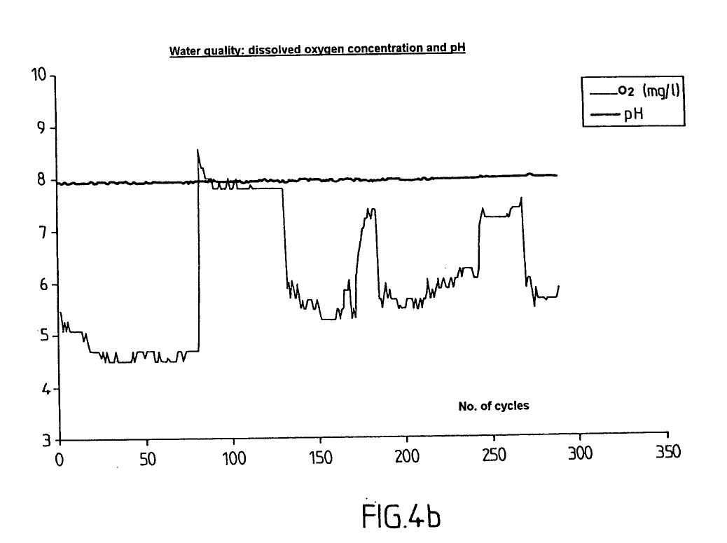

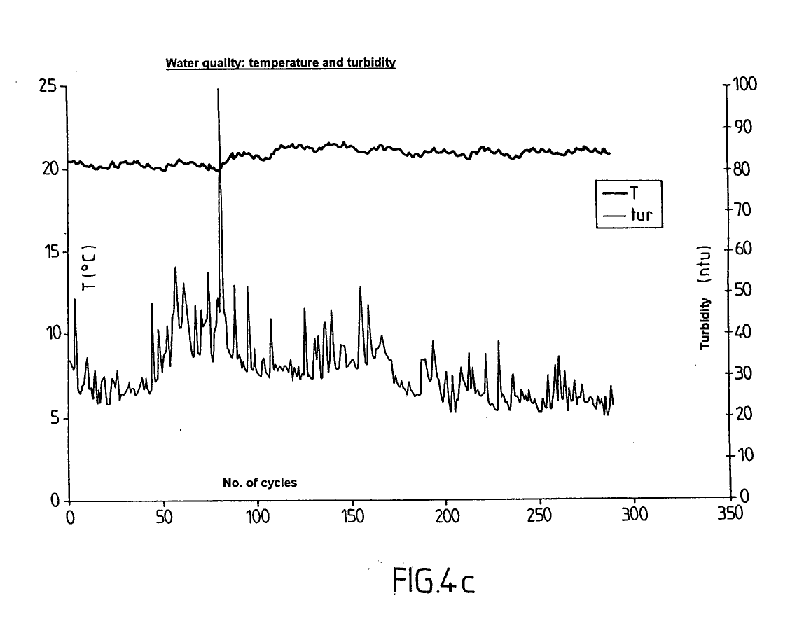

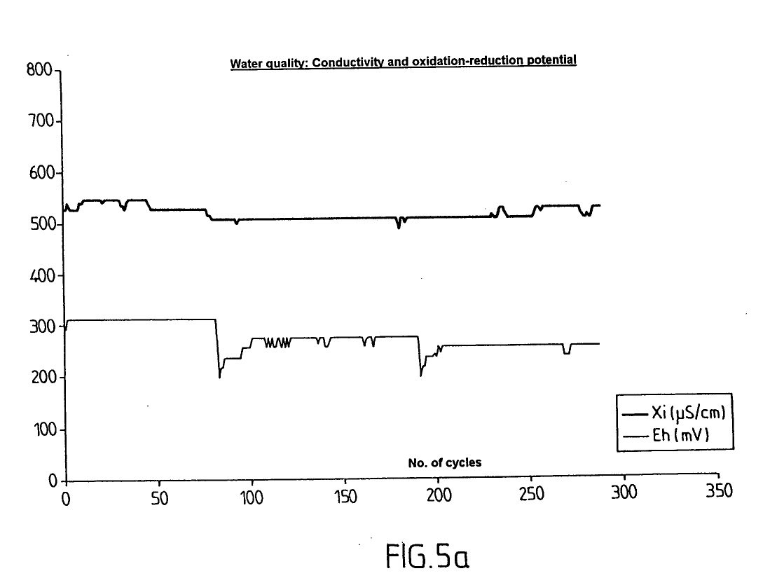

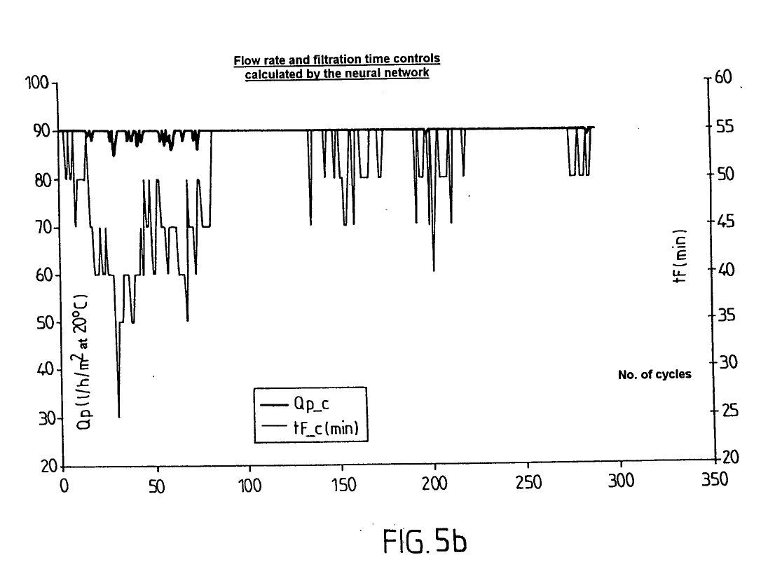

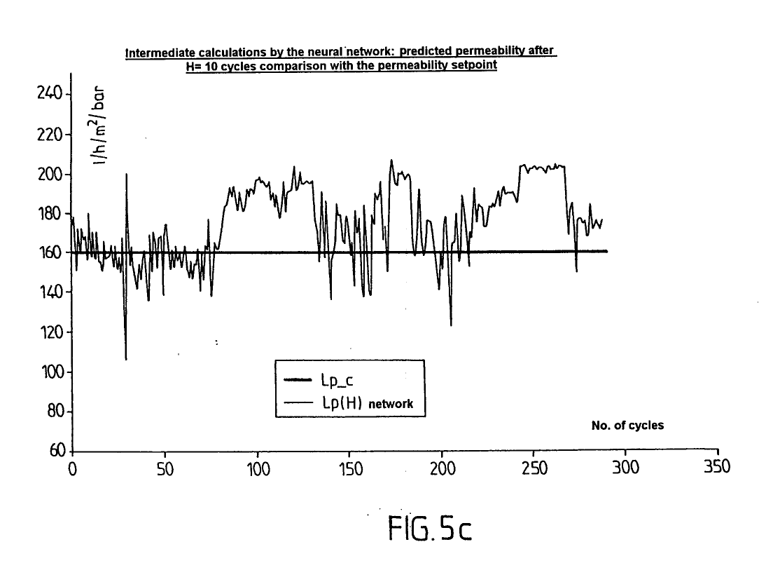

The method of regulation forming the subject-matter of the invention was validated on site. An example of the results obtained over about one week of manipulation is illustrated by the curves in FIGS. 4a to 4c and 5a to 5c in which the number of operating cycles is plotted on the x-axis and the various measured parameters of the water quality, the permeability, the permeability prediction after H cycles by the model and the permeate flow rate and filtration time controls are plotted on the y-axis.

Thanks to the invention, it has been possible to maintain a permeability above a fixed limit, for several days, by varying the filtration time t_{F} and the permeate flow rate Qp in order to limit the amount of clogging of the ultrafiltration membranes.

Of course, it remains to be stated that the present invention is not limited to the embodiments described and illustrated above, rather it encompasses all variants thereof, such as those employing hydropneumatic or pneumatic washing operations or making use of operating parameters other than the permeate flow rate or the filtration time.

1. Method of regulating a membrane filtration plant, especially in a potable water production station, designed so as to prevent irreversible clogging of the membranes while maximizing the productivity, whatever the quality of the fluid entering the plant, characterized in that it consists in slaving the plant operating parameters to the performance characteristics induced by the quality of the fluid to be treated, according to the predictions about the change in membrane clogging made by neural network modelling so as to simulate the long-term operation of the membrane filtration plant, the model making it possible:
according to the quality of the incoming fluid and the state of the membranes during a given cycle, to calculate the change in the state of clogging of the said membranes as a function of time, over a defined horizon, the said calculation being carried out for a simulated quality of the incoming fluid, the said quality being constant or varying, over this horizon (H), and
to monitor and adjust the plant operating parameters.

2. Method according to claim 1, characterized in that a clogging level limit is imposed, the regulation being carried out in such a way that the plant operates with a clogging level equal to or less than this limit.

3. Method according to claim 2, characterized in that, at each production cycle:
the experimental values of all the quality parameters and operating conditions are determined on the plant;
the parameters are entered as input into the clogging prediction model based on neural networks, which calculates the change in the clogging over a prediction horizon (H), thereby making it possible to predict the permeability after H production cycles;
the net flow rate imposed is decreased when the permeability after H cycles is less than the permeability limit (Lp_c); and
the net flow rate imposed is increased when the permeability after H cycles is greater than the permeability limit (Lp_c) by varying the permeate flow rate and/or the filtration time.

4. Method according to claim 3, characterized in that the respective values of the permeate flow rate-filtration time pair are slaved in such a way that the permeability after H cycles is equal to or greater than the permeability limit (Lp_c) and that the net flow rate is as high as possible.

5. Method according to claim 3, characterized in that the respective values of one or more of the following operating parameters are slaved:
permeate flow rate or transmembrane pressure, depending on whether the operation is carried out, in production, at constant pressure or at constant flow rate;
filtration time;
circulation flow rate, with possible switching from a recirculation mode to a transverse mode;
purge flow rate of the circulation loop;
backwashing time;
backwashing pressure or backwashing flow rate, depending on whether the operation is carried out at constant pressure or at constant flow rate for the backwashing;
concentration of dissolved chlorine or any other additive in the backwashing water; and
injection/dosing parameters for an additive during the filtration cycle.
